(19) United States
(12) Patent Application Publication
(10) Pub. No.: US 2014/0324356 A1
(43) Pub. Date: Oct. 30, 2014

(54) APPARATUS FOR EVALUATING SAFETY OF BUILDING USING EARTHQUAKE ACCELERATION MEASUREMENT

(71) Applicant: REPUBLIC OF KOREA (NATIONAL DISASTER MANAGEMENT INSTITUTE), Seoul (KR)

(72) Inventors: Byung Cheol PARK, Incheon (KR); Ji Young SEONG, Seoul (KR); Ki Hwan LIM, Gangwon-do (KR); Ki Jong PARK, Seoul (KR); Seong-Hoon Jeong, Incheon (KR); Kwang Ho LEE, Seoul (KR); Won Seok JANG, Incheon (KR); Woon Kwang YEO, Seoul (KR); Jae Hyun SHIM, Seoul (KR)

(73) Assignee: REPUBLIC OF KOREA (NATIONAL DISASTER MANAGEMENT INSTITUTE), Seoul (KR)

(21) Appl. No.: 14/264,068

(22) Filed: Apr. 29, 2014

(30) Foreign Application Priority Data
Apr. 30, 2013 (KR) 10-2013-0048438

(51) Int. Cl. G01V 1/30; G01M 7/00; G01V 1/00

(52) U.S. Cl. CPC G01V 1/30; G01V 1/008; G01M 7/00
USPC 702/15

(57) ABSTRACT

Disclosed herein is an apparatus for evaluating the safety of a building. The apparatus includes first and second measurement instruments which measure earthquake accelerations of the top and bottom stories, a fast Fourier transform unit which performs fast Fourier transform on the earthquake accelerations, an integration unit which double-integrates the measured earthquake accelerations and creates drift data of the top story and the bottom story, a maximum inter-story drift ratio calculation unit which calculates a maximum inter-story drift ratio, a natural frequency change rate calculation unit which determines a natural frequency of the building, and compares the natural frequency with an ambient natural frequency of the building so as to calculate a natural frequency change rate, and a building safety evaluation unit which compares the maximum inter-story drift ratio and the frequency change rate with preset evaluation criteria and outputs a result of evaluation in the safety of the building.

### BACKGROUND OF THE INVENTION

1. Field of the Invention

The present invention relates generally to apparatuses for evaluating the safety of buildings using an earthquake acceleration measurement and, in more detail, to an apparatus for evaluating the safety of a building which analyzes earthquake acceleration data measured in the building and a flee field and determines various evaluation indexes for use in evaluation of the safety of the building, whereby when an earthquake occurs, evaluation in the safety of the building can be rapidly and precisely conducted. Particularly, the present invention relates to an apparatus for evaluating the safety of a building which creates and uses normalized evaluation indexes to provide a measurement management system which can objectively analyze and evaluate measurement data about a plurality of buildings using the same management criteria.

2. Description of the Related Art

At present (2014), criteria for the installation and management of earthquake acceleration measurement instruments in public facilities for calculating possible earthquake damage to the facilities and evaluating the safety of such facilities is set and managed.

According to [Criteria in installation and management of earthquake acceleration measurement instuments] (notified as No. 2010-30, established on Sep. 7, 2010 in Korea) which is being managed, facilities which are targets for installation of earthquake acceleration measurement instruments are classified into nine kinds of facilities: buildings, airport facilities, dams and reservoirs, each having occupancy category I & H and the remaining facilities including suspension bridges, cable-stayed bridges, gas facilities, high-speed railroads, nuclear power plants, substations in the 357 kv or higher class, hydroelectric generating facilities and thermal power facilities. The kinds of installation-target facilities in each classification are designated in detail.

Furthermore, using acceleration response signals of each of the facilities, proper management criteria according to the characteristics of the corresponding facility and accompanying measures have been established.

However, such management criteria is limited to public buildings such as buildings of Central Government Complex or the government office buildings of local autonomous entities, airports, dams, large bridges, gas facilities, high-speed railroads, atomic energy facilities, substations, power generating facilities, etc. Therefore, for general facilities, a separate self-contained earthquake damage determination system is required. Furthermore, in the case of a public building, although it can be used as an all-source situation room (ASSR) and a shelter in an event of disaster, it is difficult for a non-specialist to analyze an earthquake acceleration measurement signal and determine the safety of the building.

Given this, even for general use buildings, a building safety evaluation technique that can be used for setting management criteria appropriate to the corresponding building and management thereof is required.

### SUMMARY OF THE INVENTION

Accordingly, the present invention has been made keeping in mind the above problems occurring in the prior art and an object of the present invention is to provide an apparatus for evaluating the safety of a building using an earthquake acceleration measurement which analyzes earthquake acceleration responses measured in the building and a free field and determines various evaluation indexes for use in evaluation of the safety of the building, whereby when an earthquake occurs, evaluation of the safety of the building can be rapidly and precisely conducted.

Another object of the present invention is to provide an apparatus for evaluating the safety of a building using an earthquake acceleration measurement which creates evaluation indexes which make it possible to objectively analyze and evaluate measurement data about a plurality of buildings using the same management criteria.

In order to accomplish the above object, the present invention provides an apparatus for evaluating safety of a building using an earthquake acceleration measurement including: a first earthquake acceleration measurement instrument and a second earthquake acceleration measurement instrument respectively installed in a top story and a bottom story of the building, the first and second earthquake acceleration measurement instruments respectively measuring earthquake accelerations of the top story and the bottom story of the building; a fast Fourier transform unit performing fast Fourier transform on the earthquake accelerations respectively measured by the first and second earthquake acceleration measurement instruments and transforming the earthquake accelerations measured in the top story and the bottom story of the building from a time-domain function into a frequency-domain response function; an integration unit double-integrating the earthquake accelerations respectively measured by the first and second earthquake acceleration measurement instruments and creating drift data of the top story and drift data of the bottom story of the building; a maximum inter-story drift ratio calculation unit calculates a maximum inter-story drift ratio of the building using the drift data of the top story and the bottom story of the building and a height of the building; a natural frequency change rate calculation unit determining a frequency, at which a value of a transfer function calculated using a ratio of a frequency-domain response function of the top story to a frequency-domain response function of the bottom story is maximal, as a natural frequency of the building, and comparing the natural frequency with an ambient natural frequency of the building preset before an earthquake occurs, thus calculating a natural frequency change rate; and a building safety evaluation unit comparing the maximum inter-story drift ratio and the frequency change rate with preset evaluation criteria and outputting a result of evaluation in the safety of the building.

The integration unit include: a band-pass filter passing a frequency band having a specific bandwidth with regard to a signal including earthquake acceleration data measured by the first and second earthquake acceleration measurement instruments; and a base line correction unit conducting a baseline correction.

The maximum inter-story drift ratio calculation unit may calculate the maximum inter-story drift ratio by means of multiplying a value, obtained by dividing a maximum value of a relative drift between the top story and the bottom story of the building at the same time by the height of the building, by a preset inter-story drift compensation factor and a response compensation factor.

The natural frequency change rate calculation unit may equalize the ratio of the frequency-domain response functions of the top story and the bottom story that are transformed by the fast Fourier transform unit through the Fourier transform, determine a peak point of the transfer function, and determine the frequency having a maximum value to be the natural frequency of the building.

The natural frequency change rate calculation unit may calculate the natural frequency change rate (Δfₙ) from formula Δfₙ=(fₙ−fₙ′)/f₁ using the ambient natural frequency (fₙ) and a natural frequency (fₙ′) measured when the earthquake occurs.

The ambient natural frequency may be determined as a frequency having a maximum value by respectively transforming pieces of earthquake acceleration data, measured by the first and second earthquake acceleration measurement instruments before the earthquake, into frequency-domain response functions using the fast Fourier transform unit, and then equalizing the ratio of the frequency-domain response functions transformed by the natural frequency change rate calculation unit and determining a peak point of the transfer function.

The ambient natural frequency may be determined as a reciprocal of a natural frequency calculated by a simple formula of a building natural period, the simple formula being proposed in an architecture design criteria {KBC (Korean Building Code)-2009} according to a kind of framework of the budding.

The apparatus may further include: a third earthquake acceleration measurement instrument installed on the ground on which the building is constructed, the third earthquake acceleration measurement instrument measuring an earthquake acceleration of a free field; a peak horizontal ground acceleration calculation unit combining maximum values of horizontal components of the earthquake acceleration of the free field measured by the third earthquake acceleration measuring instrument, and calculating a peak horizontal ground acceleration of the free field; and a design-ground-acceleration excess rate calculation unit calculating a design-ground-acceleration excess rate using the peak horizontal ground acceleration of the free field and a design ground acceleration, the design ground acceleration being preset when the building is designed, wherein the building safety evaluation unit compares the design-ground-acceleration excess rate with the preset evaluation criteria, and outputs the result of evaluation in the safety of the building.

The design earthquake ground acceleration excess rate calculation unit may set a seismic zone factor according to the architecture design criteria in response to man earthquake zone where the building is located, and use a site amplification factor according to a ground condition, thus calculating the design-ground-acceleration excess rate for use in earthquake-resistant design of the building.

The peak horizontal ground acceleration calculation unit may determine the peak horizontal ground acceleration by calculating an east-western directional maximum value and a north-south directional maximum value of the earthquake acceleration measured by the third earthquake acceleration measurement instrument and combining the east-western directional maximum and the north-south directional maximum value using an SRSS (Square Root of Sum of Squares) method.

The design-ground-acceleration excess rate calculation unit may calculate the design-ground-acceleration excess rate from formula ‘peak horizontal ground acceleration of free field−design ground acceleration)/(design ground acceleration)’.

According to the present invention, various indexes for evaluation of the safety of a building are provided, whereby safety evaluation can be rapidly and precisely performed when an earthquake occurs.

Particularly, in the present invention, when an earthquake occurs or after an earthquake has occurred even if a building manager conducts no separate assessment work, evaluation in the safety of the building can be rapidly conducted as follows: values related to various evaluation indexes that can evaluate the safety of the building are calculated using earthquake accelerations measured by earthquake acceleration measurement instruments installed in the building the calculated values are compared with safety evaluation criteria corresponding to the evaluation indexes; and the result of the evaluation in the safety of the building is output. Thereby, the present invention can be effectively used to protect property and the lives of residents in a building.

Furthermore, in the present invention, the evaluation indexes for use in evaluation of the safety of the building are expressed in a form of a normalized ratio rather than using absolute values. Therefore, the same management criteria can be used to evaluate and compare measurement data for various public buildings scattered all over the country. As a result, work efficiency can be enhanced, and objectivity in evaluation analysis can be ensured.

### BRIEF DESCRIPTION OF THE DRAWINGS

The above and other objects, features and advantages of the present invention will be more dearly understood from the following detailed description taken in conjunction with the accompanying drawings, in which:

FIG. 1 is a block diagram showing an apparatus for evaluating safety of a building using an earthquake acceleration measurement according to an embodiment of the present invention;

FIG. 2 is a view illustrating a procedure of analyzing a maximum inter-story drift ratio using acceleration response measured by an earthquake acceleration measurement instrument according to an embodiment of the present invention;

FIG. 3 is a view illustrating a procedure of analyzing a natural frequency change rate according to an embodiment of the present invention;

FIG. 4 is a flowchart showing a process of determining a design ground acceleration excess rate according to an embodiment of the present invention; and

FIG. 5 is a view showing effective ground accelerations of earthquakes of a maximum predictive recurrence period of 2400 years that was obtained from research for earthquake-resistant design code I For earthquake zones.

### DESCRIPTION OF THE PREFERRED EMBODIMENTS

Hereinafter, embodiments of the present invention will be described in detail with reference to the attached drawings. Those skilled in the art will appreciate that various modifications are possible, and the present invention is not limited to the following embodiment. Furthermore, the embodiment of the present invention aims to help those with ordinary knowledge in this art more clearly understand the present invention. The terms and words used for elements in the description of the present invention have been determined in consideration of the functions of the elements in the present invention. The terms and words may be changed depending on the intention or custom of users or operators, so that they should not be construed as limiting elements of the present invention.

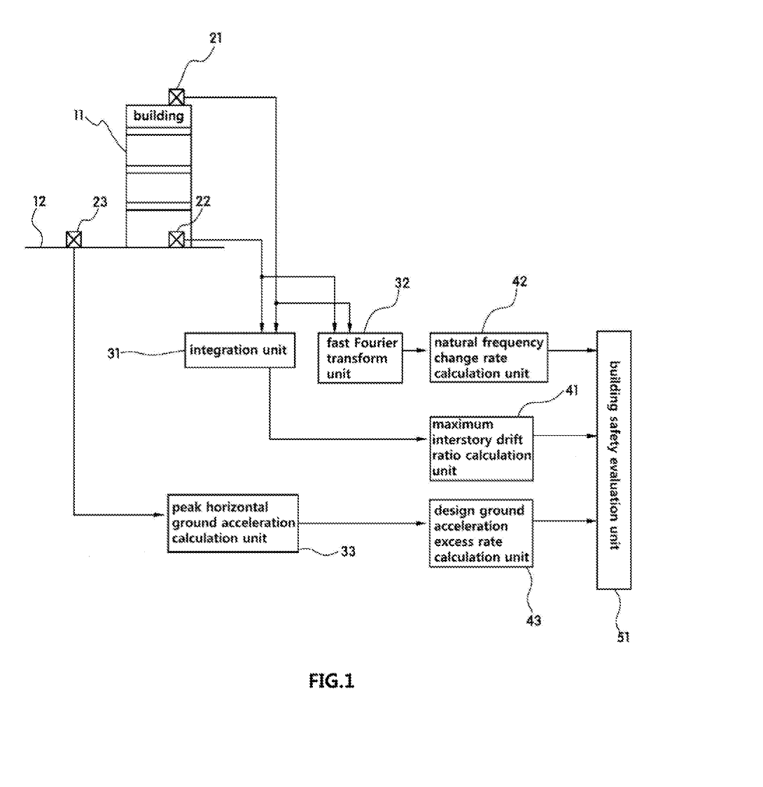

FIG. 1 is a block diagram showing an apparatus for evaluating safety of a building using earthquake acceleration measurement according to an embodiment of the present invention.

Referring to FIG. 1, the building safety evaluating apparatus using earthquake acceleration measurement according to the embodiment of the present invention inches a first earthquake acceleration measurement instrument 21, a second earthquake acceleration measurement instrument 22, an integration unit 31, a maximum inter-story drift ratio calculation unit 41, a fast Fourier transform unit 32, natural frequency change rate calculation unit 42 and a building safety evaluation unit 51. The first and second earthquake acceleration measurement instruments 21 and 22 are respectively installed in a top story and a bottom story of a building 11 so as to measure earthquake accelerations of the top story and the bottom story of the building 11. The integration unit 31 double-integrates the earthquake accelerations that are respectively measured by the first and second earthquake acceleration measurement instruments 21 and 22 and creates drift data of the top story and the bottom story of the building 11. The maxima inter-story drift ratio calculation unit 41 calculates a maximum inter-story drift ratio using the drift data of the top story and the bottom story of the building 11 and the height of the building 11. The fast Fourier transform unit 32 performs FFT (Fast Fourier Transform) on the earthquake accelerations that are respectively measured by the first and second earthquake acceleration measurement instruments 21 and 22 and transforms the earthquake accelerations measured in the top story and the bottom story of the building 11 from a time-domain function into a frequency-domain response function. The natural frequency change rate calculation unit 42 calculates a natural frequency change rate using the frequency-domain response functions of the top story and the bottom story of the building and a preset ambient natural frequency of the building 11. The building safety evaluation unit 51 compares the maximum inter-story drift ratio calculated by the maximum inter-story drift ratio calculation unit 41 and the frequency change rate calculated by the frequency change rate calculation unit 42 with preset evaluation criteria and outputs results of safety evaluation of the building 11.

The building safety evaluating apparatus according to the embodiment of the present invention further includes a third earthquake acceleration measurement instrument 23, a peak horizontal ground acceleration calculation unit 33 and a design-ground-acceleration excess rate calculation unit 43. The third earthquake acceleration measurement instrument 23 is installed on the ground 12 on which the building 11 is constructed and measures an earthquake acceleration of a flee field. The peak horizontal ground acceleration calculation unit 33 calculates a peak horizontal ground acceleration using the earthquake acceleration of the flee field that is measured by the third earthquake acceleration measurement instrument 23. The design-ground-acceleration excess rate calculation unit 43 calculates a design-ground-acceleration excess rate using the peak horizontal ground acceleration of the free field and a design ground acceleration for use in designing the building 11. The building safety evaluation unit 51 compares the design-ground-acceleration excess rate calculated by the design-ground-acceleration excess rate calculation unit 43 with the preset evaluation criteria, thus evaluating the safety of the building.

The operation and effect of the building safety evaluating apparatus using an earthquake acceleration measurement according to the embodiment of the present invention having the above-mentioned construction will be described in detail.

According to the building safety evaluating apparatus according to the embodiment of the present invention, a maximum inter-story drift ratio, a natural frequency change rate and a design-ground-acceleration excess rate are used as evaluation indexes for the safety of the building. Hereinafter, the building safety evaluation indexes will be explained in detail and the operation and effect of the elements for use in deriving the indexes will be explained in detail.

Aside from a special case where the seismic center that is the starting point of an earthquake is very close to a site on which the corresponding building is present, a horizontal component is generally predominant in earthquake vibrations. Therefore, it can be assumed that the direction in which earthquake force is applied to the building and the direction the building is moved by the earthquake force is horizontal. Drift, stiffness and strength of the building that are used to derive the building safety evaluation indexes defined in the embodiment of the present invention are in respect to the horizontal direction.

1. Maximum Inter-Story Drift Ratio

Drift is the most direct index in indicating the behavior of the building. However, a dynamic displacement system is limited in installation place, etc., because it must be manufactured and installed with an anticipated maximum drift distance of the building resulting from the occurrence of an earthquake. Furthermore, because of movement of the displacement system itself in earthquake, there is a limit on precise measurement. Given these limitations and problems, use of the displacement system in a real building not in a test model, is unrealistic. Therefore, in an embodiment of the present invention, the method used is a method of evaluating the safety of the building using an existing earthquake acceleration measurement instrument that has been installed to determine the behavior of the building.

Correlation between the drift of building and the degree of damage to it changes depending on the structure type and scale (the number of stories) of the building. If the safety of the building is evaluated using physical quantities such as an inter-story drift and an absolute drift of the top story, objective comparison evaluation of data measured in various public buildings nationwide is difficult. Given this, in an embodiment of the present invention, an inter-story drift ratio that is a relative ratio, rather than an absolute value, is used as an evaluation index so as to manage measurement data of the whole country as a constant value. Thereby, the safety of public buildings nationwide can be rapidly evaluated using the same safety management criteria.

The maximum inter-story drift ratio is a value obtained by dividing a maximum story drift value by the height of the corresponding story. Due to limited cost or space, the earthquake acceleration measurement instrument cannot be typically installed in every story. In this embodiment of the present invention, a method in which the maximum inter-story drift ratio is calculated by multiplying the maximum drift ratio of the top story by an inter-story drift compensation factor and a response compensation factor is used. The maximum drift ratio of the top story is calculated by dividing the maximum value of a relative drift between the top story and the bottom story by the height h of the top story. The maximum inter-story drift ratio can be expressed as Formula 1.

$${δ}_{max} ( maximum interstory drift ratio ) = α \times β \times \frac{{μ}_{max}}{h} \qquad [ Formula 1 ]$$

In Formula 1, δₘₐₓ, μₘₐₓ and h respectively denote a maximum inter-story drift ratio, a maximum value of a relative drift of the top story and a height of the top story. α denotes an inter-story drift compensation factor and is used to compensate for a difference between the inter-story drift ratio of the building and the maximum drift ratio of the top story attributable to uneven distribution of lateral stiffness and weight. β denotes a response compensation factor and is a factor for reflecting effects of a higher order mode and nonlinear response.

The inter-story drift compensation factor is calculated by multiplying a maximum value of a first-order mode inter-story drift ratio by the height of the top story and can be obtained by Formula 2.

α=Max{(Φ₁−φₜ₋₁)hᵢ}×h [Formula 2]

In Formula 2, and φ₁ and φₜ₋₁ respectively denote mode drift values of the corresponding story and the lower story in a first-order mode shape in which the drift of the top story is normalized as 1, hₜ and h respectively denote a height of the corresponding story and the height of the top story. Max( ) is a function for calculating the maximum value of values in the brackets.

The response compensation factor (β) is a ratio of a real maximum inter-story drift ratio of the building to a maximum inter-story drift ratio of the building that is predicted by the first-order mode. The value of the response compensation factor can be assumed to be 1.13 for low- and medium-story reinforced concrete buildings and 1.27 for steel framed buildings and determined based on the research results of analysis of earthquake behavior for buildings (Jeong, S-H, and Ehashai, A. S., “Probabilistic Fragility Analysis Parameterized by Fundamental Response Quantities”. Engineering Structures, Vol. 29, No. 6, pp. 1238-1251, 2007 and FEMA 355C, “State of the art report on systems performance of steel moment frames subject to earthquake ground shaking” Washington (DC): Federal Emergency Management Agency; 2000).

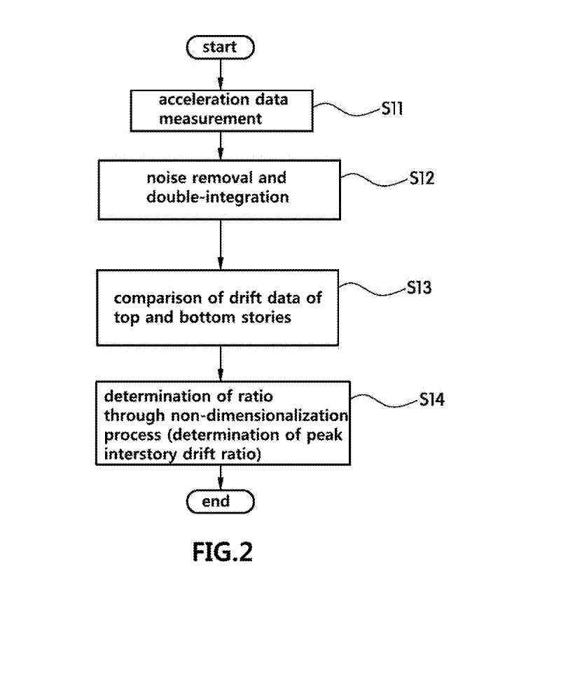

FIG. 2 is a view illustrating a procedure of analyzing the maximum inter-story drift ratio using acceleration response measured by the earthquake acceleration measurement instrument according to an embodiment of the present invention.

As shown in FIG. 2, to determine the maximum inter-story drift ratio, an analysis process is conducted, including an acceleration data measurement step S11, an acceleration measurement data noise removal and double integral step S12, a top story and bottom story drift data comparison step S13 and a maxima inter-story drift ratio calculation step S14.

The acceleration data measurement step S11 includes creating earthquake acceleration data of the bottom story and the top story that are respectively measured by the earthquake acceleration measurement instruments 21 and 22 installed in the bottom story and the top story of the building 11.

At the noise removal and double integral step S12, the integration unit 31 removes noises from a signal including the acceleration data measured by the earthquake acceleration measurement instruments 21 and 22 and double-integrates it to calculate drift data. For this, the integration unit 31 according to an embodiment of the present invention includes a band-pass filter which passes a frequency band having a specific bandwidth with regard to the signal including the earthquake acceleration data measured by the first and second earthquake acceleration measurement instruments, and a base line correction unit which performs baseline correction. The band-pass filter and the baseline correction unit respectively conduct a band pass filtering process through which only a signal within a specific frequency range is allowed to pass through the filter (E. R. Kanasewich, University of Alberta “Time Sequence Analysis in Geophysics” p. 260, 1981) and a baseline correction process (Boore, D. M, Effect of baseline corrections on displacements and response spectra for several recordings of the 1999 Chi-Chi, Taiwan, Earthquake, Bulletin of the Seismological Society of America Vol. 91, No. 5, pp. 1199-1211, 2001) whereby noises can be removed.

Thereafter, the maximum inter-story drift ratio calculation trait 41 compares the drift data of the top story with the drift data of the bottom story and calculates a maximum drift of the top story (at S13). The maximum value of relative drifts of the top story to the bottom story at the same time zones, not a difference between the maximum drift value of the top story and the maximum drift value of the bottom story, is determined as the maximum drift of the top story.

Subsequently, the maximum inter-story drift ratio calculation unit 41 conducts step S14 of determining the maximum inter-story drift ratio by means of normalization. It is not proper that the maximum drift value of the top story itself is used as an evaluation index for the safety of the building. The reason for this is because of the fact that as the height of the building increases, the drift of the top story is increased. For example, a top-story drift of 5 cm in a low-rise building and a top-story drift of 5 cm in a high-rise building have different effects on the safety of the building Therefore, in the present invention, to properly evaluate the safety of the building, the maximum drift of the top story is divided by the height of the building such that it is normalized, and then the normalized value is multiplied by the inter-story drift compensation factor and the response compensation factor, thus obtaining the maximum inter-story drift ratio. This maximum inter-story drift ratio is used in evaluating the safety of the building.

Depending on the degree of the maximum inter-story drift ratio calculated through the above-mentioned process, the structural safety of the building that is exposed to the earthquake can be evaluated. The evaluation in the safety of the building can be conducted by the building safety evaluation unit 51. Evaluation criteria for use in evaluating the safety of the building depending on the degree of the maximum inter-story drift ratio can be determined based on correlation the degree of damage to the building and the inter-story drift ratio of the building that is determined based on analysis of the accumulation data collected when earthquakes occur, analysis of data obtained by an experimental method, and opinions of expert groups. Because correlation between the inter-story drift ratio of the building and the degree of damage to the building changes depending on the structure type of the building, the evaluation criteria using the maximum inter-story drift ratio is also determined depending on the structure type of the building (a steel moment frame type, a steel eccentric braced flame type, a reinforced concrete frame type, a reinforced concrete shear wall type, etc.) Table 1 illustrates one example of safety evaluation criteria

TABLE 1

| | Safety evaluation criteria of building | | | |
|---|---|---|---|---|
| | | Inspection | | |
| | | needed | | Evacuation |
| Structure type | Safe (slight | (moderate | Extensive | (complete |
| of building | damage) | damage) | damage | damage) |
| steel moment | 0.44% or less | more than 0.44% | more than 0.7% | more than 2.5% |
| frame | | 0.7% or less | 2.5% or less | 5.0% or less |
| steel eccentric | 0.31% or less | more than 0.31% | more than 0.5% | more than 1.5% |
| braced frame | | 0.5% or less | 1.5% or less | 2.0% or less |
| reinforced | 0.5% or less | more than 0.5% | more than 0.5% | more than 2.0% |
| concrete frame | | 0.1% or less | 0.1% or less | 4.0% or less |
| reinforced | 0.25% or less | more than 0.25% | more than 0.5% | more than 1.0% |
| concrete shear | | 0.5% or less | 1.0% or less | 2.0% or less |
| wall | | | | |

2. Natural Frequency Change Rate

Generally, the degree of damage to the building is determined depending on a rate of change of stiffness. However, it is very difficult to precisely determine a rate of change of stiffness of the building that has been constructed. Given this, in an embodiment of the present invention, checking the rate of change of the building's natural frequency is used as a method of easily determining the stiffness. The natural frequency of the building is calculated by the lateral stiffness and weight of the building, and the unit of the natural frequency is hertz (Hz). This natural frequency of the building can be expressed by Formula 3.

$${f}_{n} = \frac{1}{2 π} \sqrt{\frac{k}{m}} \qquad [ Formula 3 ]$$

In Formula 3, fn, k and m respectively denote natural frequency, lateral stiffness and a weight. Damage to the building deteriorates the lateral stiffness (k) of the building, thus resulting in a change in the natural frequency (fn). Therefore, deterioration in stiffness of the building can be estimated from a change in natural frequency after an earthquake with respect to the natural frequency of the building when in an intact state before the earthquake. The natural frequency change rate can be used as an analysis index for emergency safety evaluation after the earthquake. The natural frequency change rate can be obtained by Formula 4.

Δfₙ=(fₙ−fₙ′)/fₙ [Formula 4]

In Formula 4, fₙ and fₙ′ respectively denote a natural frequency of the building when in an intact state before an earthquake occurs and a natural frequency of the building after die earthquake.

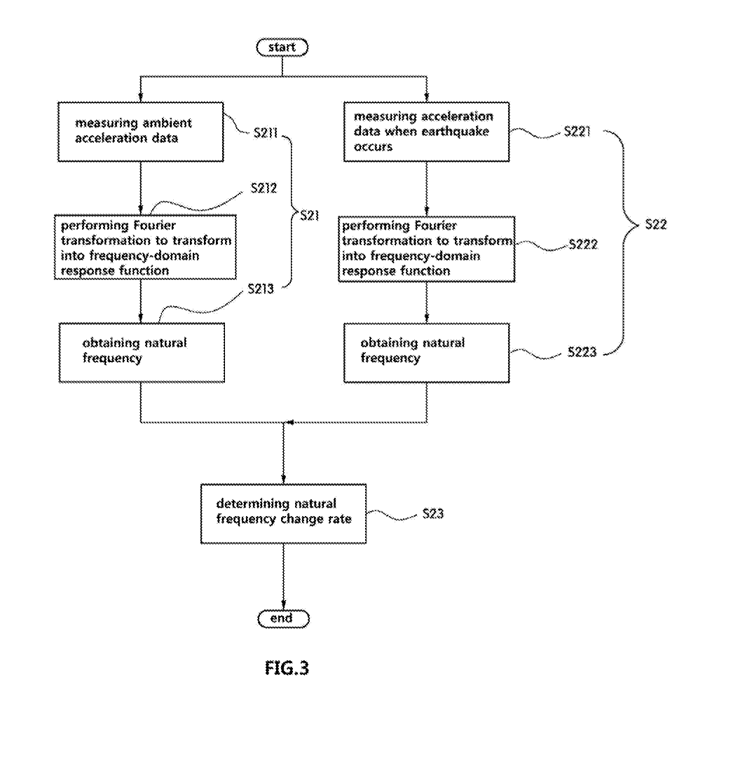

FIG. 3 is a view illustrating a procedure of analyzing a natural frequency change rate according to an embodiment of the present invention. Referring to FIG. 3, to determine the natural frequency change rate, analysis of the natural frequency with regard to data about ambient vibration acceleration measured before an earthquake occurs must be preceded before the earthquake (at S21). Subsequently, analysis of the natural frequency with regard to data about vibration acceleration measured after the building has been affected by the earthquake is conducted (at S22). Lastly, to quantitatively evaluate a change in natural frequency, a natural frequency change rate that is a normalized value is calculated by comparing the natural frequencies before and after the earthquake with each other (at S23).

The analyses of the natural frequencies before and after the earthquake are conducted through the same process. In detail, data about vibration acceleration is obtained by the earthquake acceleration measurement instruments 21 and 22 that are respectively installed in the top story and the bottom story of the building 11 (at S211, S221). Thereafter, the fast Fourier transform unit 32 conducts an FFT to transform time-domain acceleration data into frequency-domain data (at S212, S222). Thereafter, the natural frequency change rate calculation unit 42 produces a transfer function (refer to Applied Technology Council Tentative provisions for the development of seismic regulations for buildings, ATC3-06. Applied Technology Council, Palo Alto, Calif., 1978) using a ratio of a frequency-domain response function of the top story to the bottom story, and determines a frequency, at which the value of the transfer function becomes the maximum, as the natural frequency of the building (at S213, S223).

Meanwhile, to determine the natural frequency change rate of the building, the original natural frequency of the building is needed. In the case where an ambient vibration acceleration measurement was taken at the initial stage (before an earthquake occurs) after the building was constructed (at S211), and thus there is a measurement value, the fast Fourier transform unit 32 performs an FFT on acceleration data obtained by the ambient measurement (at S212), thus obtaining the original natural frequency (at S213). On the other hand, in the case where the initial ambient acceleration measurement has not been conducted, the original natural frequency is determined using a natural period estimation formula introduced in an architecture design criteria (Korean Building Code (KBC-2009), The Architectural Institute of Korea). In other words, step S21 can be replaced with the step of determining the natural frequency using the KBC.

In the KBC, a calculation formula for the natural period rather than for the natural frequency is proposed. Therefore, it is important to note that a reciprocal must be used for the calculation formula. The natural period according to the KBC is obtained by Formula 5.

T_{α}=C_{T}h^{3/4} [Formula 5]

In Formula 5, C_{T} is a constant according to a structural type of the building, wherein it is 0.085 for a steel moment frame type, 0.073 for a reinforced concrete moment frame type or a steel eccentric braced frame type, and 0.049 for other structural types. Furthermore, in Formula 5, h denotes the overall height (m) of the building from the bottom to the top story.

The natural frequency of the building varies depending on the structural type, the materials, the shape, the weight, etc. of the building. Therefore, in order to determine the safety of such various kinds of buildings, it is important to determine a natural frequency change rate of the building after an earthquake with respect to the natural frequency of the building when in an intact state. Thus, in an embodiment of the present invention, the natural frequency change rate calculation unit 42 determines a natural frequency change rate of the building using Formula 4 (at S23) to estimate deterioration in stiffness of the building, thus making evaluation of damage to the building attributable to the earthquake possible.

Evaluation in safety of the building using the natural frequency change rate can be conducted by the building safety evaluation unit 51. Based on the result of research in Korea on the safety of a real building before and after being damaged though experiments (Yoon Seongwon, Park Yong, Ji Jeonghwan. Im Jaehwi, Jang Dongu, “Vibration characteristics of three-story reinforced concrete building before and after damaged” Journal of the Korean association for spatial structures, Vol. 9, No. 3, PP. 59-66, 2009), it is considered that it is preferable to set the natural frequency change rate of the building to 20% as the earthquake safety evaluation criteria. Later, there is a need for resetting the safety management criteria on the basis of data analysis result that is based on measurement data accumulation.

3. Design Ground-Acceleration Excess Rate

Aside from a special case where the seismic center that is the starting point of an earthquake is very close to a site on which the corresponding building is present, a horizontal component is generally predominant in earthquake vibration. Therefore, it can be assumed that the direction in which earthquake force is applied to the building is the horizontal direction. Given this, design criteria for ensuring the strength of a building with respect to the horizontal direction are defined in the earthquake-resistant design criteria.

The horizontal strength of the building required in the earthquake-resistant design criteria is set corresponding to design earthquake force. Here, the design earthquake force is proportional to a design ground acceleration that is equal to the intensity of the earthquake vibration of anticipated earthquakes. Therefore, an excess rate of the peak ground acceleration which is measured in a free field when a real earthquake occurs to the design ground acceleration used for determining the design load of the building can be used as an index for use in evaluating the safety of the building after the earthquake.

The design-ground-acceleration excess rate is a ratio that indicates how much the maximum value of the earthquake acceleration measured in a free field around the building exceeds the design ground acceleration according to the architectural design criteria. This is defined by Formula 6.

$$Design \text{-} ground \text{-} acceleration excess rate = \frac{\sqrt{{A}_{N}^{2} + {A}_{E}^{2}} - S}{S} \qquad [ Formula 6 ]$$

In Formula 6, A_{N} denotes a north-south directional maximum value of the earthquake acceleration that is measured in a free field when an earthquake occurs. A_{E} denotes an east-west directional maximum value of the earthquake acceleration that is measured in the free field when the earthquake occurs. S denotes a design ground acceleration used for the design load of the building.

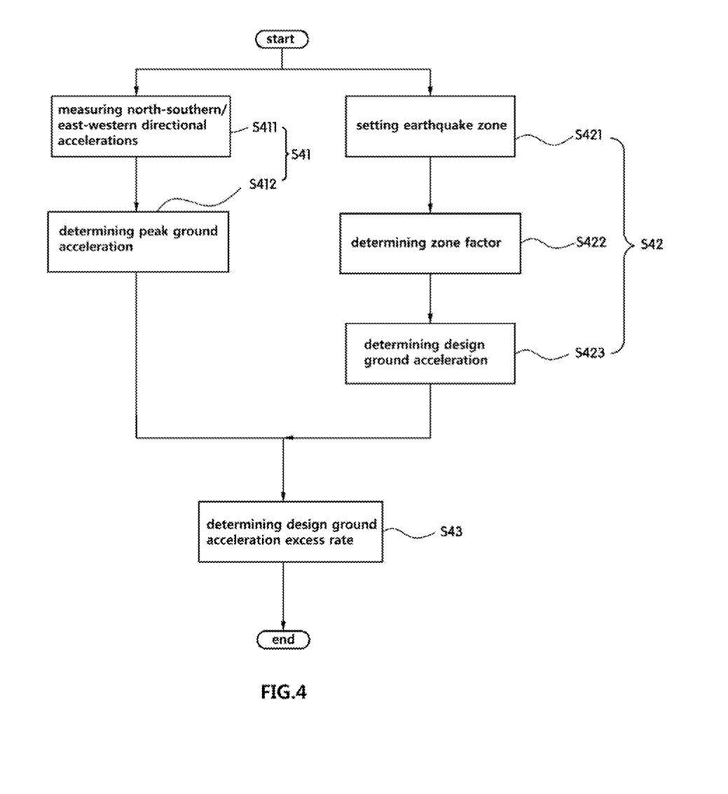

A process for analyzing the design-ground-acceleration excess rate is illustrated in FIG. 4. FIG. 4 is a flowchart showing the process of determining the design ground acceleration excess rate according to an embodiment of the present invention. Referring to FIG. 4, the process of determining the design ground acceleration excess rate includes step S41 of determining a peak horizontal ground acceleration from data measured in a free field when an earthquake occurs, step S42 of determining a design ground acceleration used in earthquake-resistant design for the corresponding building, and step S43 of calculating a design-ground-acceleration excess rate by means of comparing the values determined at steps S41 and S42 with each other.

Step S41 of determining, by the peak horizontal ground acceleration calculation unit 33, the peak horizontal ground acceleration including step S411 of measuring north-south directional and east-west directional accelerations of the free field using the earthquake acceleration measurement instrument installed in the free field on which the building is located, and step S412 of determining the maximum value of the measured accelerations as a peak ground acceleration. Here, horizontal components of the earthquake acceleration in the free field are measured in two directions, including the north-south direction and the east-west direction. The maximum values of these two components are combined into a single value to calculate the peak ground acceleration. This peak ground acceleration is compared with the design ground acceleration. An SRSS (Square Root of Sum of Squares) method can be used in combining the maximum values to calculate the peak ground acceleration. The SRSS method is expressed as Formula 7.

Peak ground acceleration=\sqrt{A_{N}²+A_{E}²} [Formula 7]

In Formula 7, A_{N} denotes a north-south directional maximum value of the free-field earthquake acceleration. A_{E} denotes an east-west directional maximum value of the free-field earthquake acceleration. The maximum values of the north-south directional component and the east-west directional component of the horizontal earthquake acceleration e calculated independently from each other.

Step S42 of determining the design ground acceleration used in the earthquake-resistant design for the building includes step S421 of setting an earthquake zone according to the architecture design criteria of the building 11, step S422 of calculating a seismic zone factor corresponding to the earthquake zone, and step S423 of applying a site amplification factor according to a ground condition.

Step S421 of setting the earthquake zone based on the zone where the site which contains the building is located, and step S422 of setting the seismic zone factor are conducted as follows.

The architecture design criteria (KBC-2009) proposes a procedure for setting an earthquake load in the earthquake-resistant design. The earthquake zone and the seismic zone factor of Korea are set as in Table 2. The seismic zone factor shows, as unit of g (9.81 m/s²), the intensity of ground vibration, which is anticipated when an earthquake of a maximum predictive recurrence period of 2400 years occurs in a corresponding earthquake zone.

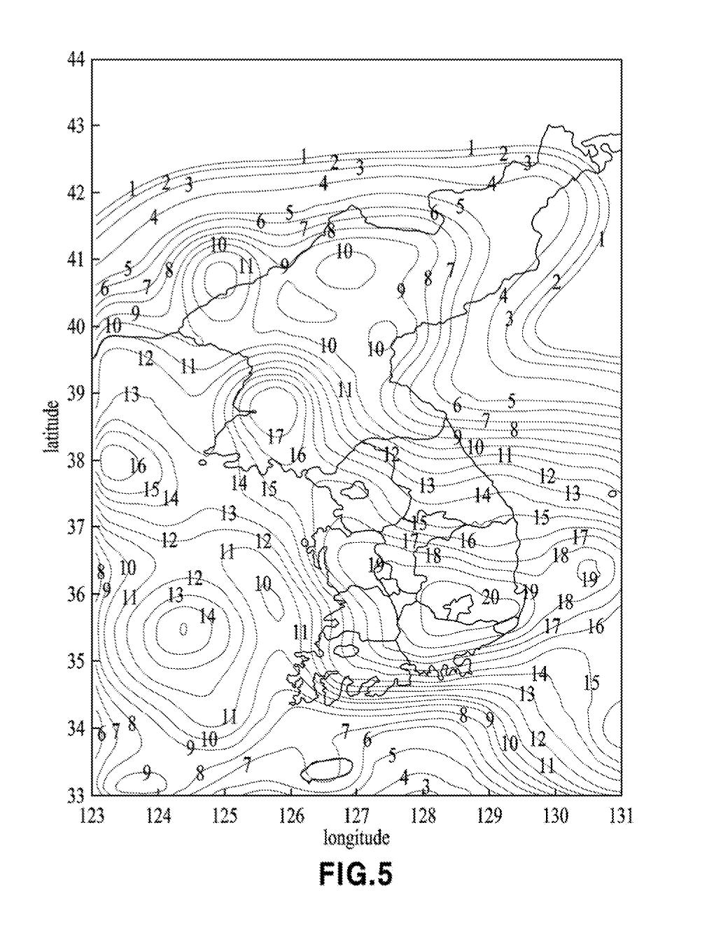

FIG. 5 is a view showing the distribution of effective ground accelerations of earthquakes of a maximum predictive recurrence period of 2400 years that was obtained from research for earthquake-resistant design code II (the Ministry of Construction and Transportation of Korea, 1997). The seismic zone factors may be determined using the effective ground accelerations. Because each effective ground acceleration is shown as percentage (%) of g (9.81 m/s²), it can be converted into a corresponding seismic zone factor by multiplying it by 100. Here, the seismic zone factors calculated using the effective ground acceleration distribution of FIG. 5 must be determined to be 80% or more of the seismic zone factors determined according to Table 2.

TABLE 2

| Earthquake | | Seismic zone |
|---|---|---|
| zones | Administrative districts | factors |
| 1 | all areas other than earthquake zone 2 | 0.22 |
| 2 | northern region of Gangwon Province, | 0.14 |
| | southwestern region of South Jeolla | |
| | Province, Jeju Island | |

* Northern region of Gangwon Province (city, district): Hongcheon, Cheorwon, Hwacheon, Hoengseong, Pyeongchang, Yanggu, Inje, Goseong, Yangyang, Chuncheon City, Sokcho City
* South-western region of South Jeolla Province (city, district): Muan, Sinan, Wando, Yeonggwang, Jindo, Haenam, Yeongam, Gangjin, Goheung, Hampyeong, Mokpo City

At step S423 of determining the design ground acceleration, the design ground acceleration is determined by multiplying the corresponding seismic zone factor by the site amplification factor corresponding to the kind of ground. The site amplification factors proposed in the architecture design criteria (KBC-2009) can be obtained from Table. 3. In Table 3, each site amplification factor that is a median value of the co seismic zone factors can be obtained by linear interpolator.

TABLE 3

| | Earthquake zones | | |
|---|---|---|---|
| The kinds | Seismic zone | Seismic zone | Seismic zone |
| of ground | factors ≦0.1 | factors = 0.2 | factors = 0.3 |
| S_{A} | 0.8 | 0.8 | 0.8 |
| S_{B} | 1.0 | 1.0 | 1.0 |
| S_{C} | 1.2 | 1.2 | 1.1 |
| S_{D} | 1.6 | 1.4 | 1.2 |
| S_{E} | 2.5 | 1.9 | 1.3 |

The kinds of grounds can be classified as in Table 4 according to the architecture design criteria (KBC-2009).

TABLE 4

| | | Mean characteristics of | | |
|---|---|---|---|---|
| | | top 10 m of ground | | |
| | | | Standard | |
| | | | penetration | Undrained |
| | The names | Shear wave | test (the | shear |
| The kinds | of kinds | velocity | number of | strength |
| of ground | of ground | (m/s) | strikes) | (×10⁻³ MPa) |
| S_{A} | Hard-rock ground | more than | — | — |
| | | 1500 | | |
| S_{B} | Ordinary-rock | 760 to 1500 | | |
| | ground | | | |
| S_{C} | Very dense earth | 360 to 760 | >50 | >100 |
| | and sand ground | | | |
| | or soft-rock | | | |
| | ground | | | |
| S_{D} | Hard earth and | 180 to 360 | 15 to 50 | 50 to 100 |
| | sand ground | | | |
| S_{E} | Soft earth and | less than | <15 | <50 |
| | sand ground | 180 | | |

In an embodiment of the present invention, because earthquake acceleration measurement data is indicated as the unit of gal (cm/s²) it is required to unite the unit of design ground acceleration into the unit of gal so that normalized indexes can be derived. For this reason, the product of the seismic zone factor and the site amplification factor which are set as the unit of g (9.81 m/s²) is multiplied by 981 to perform unit conversion into gal.

Subsequently, through the normalization process (S43), a design-ground-acceleration excess rate is derived using the design ground acceleration and the peak ground acceleration of the free field that is measured when the earthquake occurs. The design-ground-acceleration excess rate calculation unit 44 calculates the design-ground-acceleration excess rate using the peak ground acceleration of the free field and the design ground acceleration through the calculation process of FIG. 4 for normalization.

Evaluation of the safety of the building using the design-ground-acceleration excess rate can be performed by the building safety evaluation unit 51. Evaluation criteria for use in the building safety evaluation of the building safety evaluation unit 51 using the design-ground-acceleration excess rate can be determined as follows.

Complying with Korea Earthquake Recovery Plans Act [Presidential Decree No. 2136] Articles 6 and 7, and the same law enforcement ordinance Article 5 and enforcement regulations Articles 2 and 3, installation and management criteria [notified by Korea's National Emergency Management as No. 2010-3] for earthquake acceleration measurement instruments was established on Sep. 7, 2010. On the basis of this, in Korea, earthquake acceleration measurement projects for measuring and recording earthquake accelerations in national public buildings are being made. To evaluate the safety of national public buildings in a lump using objective indexes, in an embodiment of the present invention, the method using the design-ground-acceleration excess rate is proposed. When the design value and the measurement value are equal to each other, the design-ground-acceleration excess rate is indicated as 0%. If the design-ground-acceleration excess rate is a positive value, this indicates the degree of excess. For example, if the design-ground-acceleration excess rate is 10%, this means that the earthquake acceleration exceeds the design ground acceleration by 10%. If it is −10%, this means that a value which is short of the design ground acceleration by 10% is measured. At present, since the design ground acceleration is set based on the acceleration of the surface of the ground, it can be understood that when the maximum of measurement values exceeds the design value, there is a problem in the safety of the building. Therefore, it is assumed that 0% at which the measurement value is the same as the design value is a critical point of the safety state of the building, and this is set as the safety management criteria. Later, when measurement data is properly accumulated, the safety management criteria can be amended to a more rational value by analyzing correlation between the accumulated data and the safety of buildings.

In the embodiment of the present invention, normalization is conducted to propose a ratio that indicates how much the peak ground acceleration measured in a free field exceeds the design ground acceleration. Given the fact that the design ground acceleration changes depending on the characteristics of a zone and ground conditions of the zone, comparing the peak ground acceleration that is measured in the corresponding zone with the design ground value is more rational than using only the peak ground acceleration measured in a free field to evaluate the safety of the building. Moreover, because data analyzed from all over the country can be evaluated and compared under the same management criteria, work efficiency can be enhanced.

Hitherto, items used as indexes for evaluation of the safety of the building in the apparatus and method for evaluating the safety of the building using earthquake acceleration measurement according to the preferred embodiment of the present invention have been described in detail.

In the embodiment of the present invention, various evaluation indexes resulting from developing various earthquake acceleration analysis methods are proposed as a method for evaluating the safety of a building after an earthquake occurs. All evaluation indexes are proposed in a form of a normalized ratio rather than a form of absolute value. Therefore, it becomes possible to analyze measurement data about the public buildings of the whole country in a lump using objective criteria. In the procedure of analyzing the indexes for use in evaluation of the safety of the building and the safety management criteria pertaining to each index, three kinds of indexes including the maximum inter-story drift ratio, the natural frequency change rate and the design-ground-acceleration excess rate have been explained as indexes, which a general manager of the building can rapidly evaluate earthquake damage to the building when an earthquake occurs.

In the embodiment of the present invention, to analyze the accumulated data, criteria for evaluating the safety of the building are proposed as in the following Table 5. Using the criteria, the building safety evaluation unit can output the result of evaluation in the safety of the building based on each evaluation index. Each evaluation index is indicated as a form of a normalized ratio. In the analysis process, the evaluation index can be indicated in a form of a percentage by multiplying the normalized value by 100. The safety management criteria can be derived from domestic and foreign safety management criteria or experimental cases. Later, as earthquake acceleration data measured in the building is accumulated, the safety management criteria can be modified or reformed. Furthermore, the accumulated data about the results of measurement and analysis can be used to develop the earthquake-resistant technology appropriate for domestic circumstances and improve the earthquake-resistant design criteria.

TABLE 5

| Evaluation | | Safety management criteria |
|---|---|---|
| indexes | Analysis method | (safety evaluation criteria) |
| maximum inter-story | (maximum relative drift between top | steel moment frame: 0.44% or less |
| drift ratio | and bottom stories)/(height of | steel eccentric braced |
| | building) × (inter-story drift | frame: 0.31% or less |
| | condensation factor) × (response | reinforced concrete |
| | compensation factor) | frame: 0.5% or less |
| | | reinforced concrete shear |
| | | wall: 0.25% or less |
| natural frequency | (ambient natural frequency before | 20% or less |
| change rate | earthquake − natural frequency when | |
| | earthquake occurs)/(ambient natural | |
| | frequency before earthquake) | |
| design-ground- | (peak horizontal ground acceleration | 0% or less |
| acceleration | in free field − design ground | |
| excess rate | acceleration)/(design ground | |
| | acceleration) | |

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for evaluating safety of a building using an earthquake acceleration measurement, comprising:
a first earthquake acceleration measurement instrument and a second earthquake acceleration measurement instrument respectively installed in a top story and a bottom story of the building, the first and second earthquake acceleration measurement instruments respectively measuring earthquake accelerations of the top story and the bottom story of the building;
a fast Fourier transform unit performing fast Fourier transform on the earthquake accelerations respectively measured by the first and second earthquake acceleration measurement instruments and transforming the earthquake accelerations measured in the top story and the bottom story of the building from a time-domain function into a frequency-domain response function;
an integration unit double-integrating the earthquake accelerations respectively measured by the first and second earthquake acceleration measurement instruments and creating drift data of the top story and drift data of the bottom story of the building;
a maximum inter-story drift ratio calculation unit calculates a maximum inter-story drift ratio of the building using the drift data of the top story and the bottom story of the building and a height of the building;
a natural frequency change rate calculation unit determining a frequency, at which a value of a transfer function calculated using a ratio of a frequency-domain response function of the top story to a frequency-domain response function of the bottom story is maximal, as a natural frequency of the building, and comparing the natural frequency with an ambient natural frequency of the building preset before an earthquake occurs, thus calculating a natural frequency change rate; and
a building safety evaluation unit comparing the maximum inter-story drift ratio and the frequency change rate with preset evaluation criteria and outputting a result of evaluation in the safety of the building.

2. The apparatus as set forth in claim 1, wherein the integration unit comprises:
a band-pass filter passing a frequency band having a specific bandwidth with regard to a signal including earthquake acceleration data measured by the first and second earthquake acceleration measurement instruments; and
a base line correction unit conducting a baseline correction.

3. The apparatus as set forth in claim 1, wherein the maximum inter-story drift ratio calculation unit calculates the maximum inter-story drift ratio by means of multiplying a value, obtained by dividing a maximum value of a relative drift between the top story and the bottom story of the building at the same time by the height of the building, by a preset inter-story drift compensation factor and a response compensation factor.

4. The apparatus as set forth in claim 1, wherein the natural frequency change rate calculation unit equalizes the ratio of the frequency-domain response functions of the top story and the bottom story that are transformed by the fast Fourier transform unit through the Fourier transform, determines a peak point of the transfer function, and determines the frequency having a maximum value to be the natural frequency of the building.

5. The apparatus as set forth in claim 4, wherein the natural frequency change rate calculation unit calculates the natural frequency change rate (Δfₙ) from formula Δfₙ=(fₙ−fₙ′)/f₁ using the ambient natural frequency (fₙ) and a natural frequency (fₙ′) measured when the earthqlake occurs.

6. The apparatus as set forth in claim 1, wherein the ambient natural frequency is determined as a frequency having a maximum value by respectively transforming pieces of earthquake acceleration data, measured by the first and second earthquake acceleration measurement instruments before the earthquake, into frequency-domain response functions using the fast Fourier transform unit, and then equalizing the ratio of the frequency-domain response functions transformed by the natural frequency change rate calculation unit and determining a peak point of the transfer function.

7. The apparatus as set forth in claim 1, wherein the ambient natural frequency is determined as a reciprocal of a natural frequency calculated by a simple formula of a building natural period, the simple formula being proposed in an architecture design criteria {KBC (Korean Building Code)-2009}according to a kind of framework of the building.

8. The apparatus as set forth in claim 1, further comprising:
a third earthquake acceleration measurement instrument installed on the ground on which the building is constructed, the third earthquake acceleration measurement instrument measuring an earthquake acceleration of a free field;
a peak horizontal ground acceleration calculation unit combining maximum values of horizontal components of the earthquake acceleration of the free field measured by the third earthqlake acceleration measuring instrument, and calculating a peak horizontal ground acceleration of the free field, and
a design-ground-acceleration excess rate calculation unit calculating a design-ground-acceleration excess rate using the peak horizontal ground acceleration of the free field and a design ground acceleration, the design ground acceleration being preset when the building is designed,
wherein the building safety evaluation unit compares the design-ground-acceleration excess rate with the preset evaluation criteria, and outputs the result of evaluation in the safety of the building.

9. The apparatus as set forth in claim 8, wherein the design ground-acceleration excess rate calculation unit sets a seismic zone factor according to the architecture design criteria in response to an earthquake zone where the building is located, and uses a site amplification factor according to a ground condition, thus calculating the design-ground-acceleration excess rate for use in earthquake-resistant design of the building.

10. The apparatus as set forth in claim 8, wherein the peak horizontal ground acceleration calculation unit determines the peak horizontal ground acceleration by calculating an east-western directional maximum value and a north-south directional maximum value of the earthquake acceleration measured by the third earthquake acceleration measurement instrument and combining the east-western directional maximum and the north-south directional maximum value using an SRSS (Square Root of Sum of Squares) method.

11. The apparatus as set forth in claim 8, wherein the design-ground-acceleration excess rate calculation unit calculates the design-ground-acceleration excess rate from formula ‘peak horizontal ground acceleration of flee field−design ground acceleration)(design ground acceleration)’.
